(19) United States
(12) Patent Application Publication
(10) Pub. No.: US 2021/0176329 A1
(43) Pub. Date: Jun. 10, 2021

(54) SYSTEM SUPPORTING FAULT TOLERANCE AND CONTROL METHOD THEREOF

(71) Applicant: INDUSTRIAL TECHNOLOGY RESEARCH INSTITUTE, Hsinchu (TW)

(72) Inventors: Sheng-Kai LIN, Changhua County (TW); Po-Jui TSAO, Taipei City (TW); Yu-Shiang LIN, Tainan City (TW)

(73) Assignee: INDUSTRIAL TECHNOLOGY RESEARCH INSTITUTE, Hsinchu (TW)

(21) Appl. No.: 16/941,187

(22) Filed: Jul. 28, 2020

(30) Foreign Application Priority Data
Dec. 4, 2019 (TW) 108144322

(51) Int. Cl. H04L 29/08; G06F 9/455; G06F 3/06; G06F 11/30; G06F 11/34; H04L 29/06

(52) U.S. Cl. CPC H04L 67/2842; G06F 9/45558; G06F 3/0619; G06F 3/065; G06F 2009/45595; G06F 3/067; G06F 11/301; G06F 11/3495; H04L 69/16; G06F 3/0664

(57) ABSTRACT

A control method of a system supporting fault tolerance is provided, at first, a first host executes a transmission control protocol agent to receive a data stream from a client device. Then the TCP agent transmits an acknowledgement packet to the client device in response to the data stream from the client device. Then the TCP agent determines whether a fault tolerance mechanism of the virtual machine is activated. When the TCP agent determines that the fault tolerance mechanism of the virtual machine is activated, the TCP agent determines whether the virtual machine operates in a running state. When the TCP agent determines that the virtual machine is not in the running state, the TCP agent temporarily storing the data stream. When the TCP agent determines that the virtual machine operates in a running state, the TCP agent transmits the data stream to the virtual machine.

### CROSS-REFERENCE TO RELATED APPLICATIONS

This non-provisional application claims priority under 35 U.S.C. § 119(a) on Patent Application No(s). 108144322 filed in Republic of China on Dec. 4, 2019, the entire contents of which are hereby incorporated by reference.

### BACKGROUND

### 1. Technical Field

This disclosure relates to a host system supporting fault tolerance.

### 2. Related Art

A virtual machine in a host completely backs up states of peripheral inputs/outputs of the virtual machine and a state of a memory of the virtual machine to a backup host without interruption, so that a backup virtual machine which is identical to the virtual machine is formed in the backup host, thereby achieving a fault tolerance of the virtual machine. When the virtual machine wants to send data packets to a client device, in order to keep states of the backup virtual machine to be consistent with external states, the virtual machine monitoring layer in the host temporarily stores the data packets which need to be transmitted, and then the virtual machine monitoring layer transmits the data packets to the client device until states of peripheral inputs/outputs of the virtual machine and the state of the memory are completely backed up to the backup host. After the client device receives the data packets from the host, a client application of the client device returns a confirmation packet to the host.

However, when the fault tolerance mechanism of the host is activated, the round trip time of the data packets will be increased sharply. The added round trip time is the sum of time for executing the running state of the fault tolerance mechanism, the snapshot state of the fault tolerance mechanism, the transfer state of the fault tolerance mechanism, and the flush output state of the fault tolerance mechanism. According to the current transmission control protocol (TCP) related to the network congestion control, when the round trip time of data packets becomes longer, the network transmission rate will be greatly reduced. It can be seen that although the host can achieve the purpose of state backup after the fault tolerance mechanism is activated, it actually causes a problem of decreasing the network transmission rate.

In view of the above situations, there is indeed a need for an improved system supporting fault tolerance, the improved system not only achieves the purpose of state backup, but also improve the problem of decreasing the network transmission rate.

### SUMMARY

According to one or more embodiment of this disclosure, a control method of a system supporting fault tolerance is provided, wherein the system comprises a first host and a second host and the first host and the second host are configured to connected to a client device via an internet, the first host stores a virtual machine and a transmission control protocol agent, and with the control method comprising: via the first host, executing the transmission control protocol agent to receive a data stream from the client device; via the transmission control protocol agent, in response to the data stream from the client device, transmitting an acknowledgement packet to the client device via the transmission control protocol agent; via the transmission control protocol agent, determining whether a fault tolerance mechanism of the virtual machine is activated; via the transmission control protocol agent, determining whether the virtual machine operates in a running state when the transmission control protocol agent determines that the fault tolerance mechanism of the virtual machine is activated; via the transmission control protocol agent, temporarily storing the data stream when the transmission control protocol agent determines that the virtual machine is not in the running state; and via the transmission control protocol agent, transmitting the data stream to the virtual machine when the transmission control protocol agent determines that the virtual machine operates in the running state.

According to one or more embodiment of this disclosure, another control method of a system supporting fault tolerance is provided, wherein the system comprises a first host and a second host and the first host and the second host are configured to connected to a client device via an internet, the first host stores a virtual machine and a transmission control protocol agent, and with the control method comprising: via the first host, executing the transmission control protocol agent to receive a data stream from the virtual machine; in response to the data stream from the virtual machine, transmitting an acknowledgement packet to the virtual machine via the transmission control protocol agent; via the transmission control protocol agent, determining whether a fault tolerance mechanism of the virtual machine is activated; via the transmission control protocol agent, determining whether states of the virtual machine are completely backed up to the second host when the transmission control protocol agent determines that the fault tolerance mechanism of the virtual machine is activated; via the transmission control protocol agent, temporarily storing the data stream when the transmission control protocol agent determines that the states of the virtual machine are not completely backed up to the second host; and via the transmission control protocol agent, transmitting the data stream to the client device when the transmission control protocol agent determines that the states of the virtual machine are completely backed up to the second host.

According to one or more embodiment of this disclosure, a system supporting fault tolerance is provided. The system comprises a first host and a second host, the first host stores a virtual machine and a transmission control protocol agent and is configured to connect to a client device via an internet. The second host connects to the first host via the internet, and the first host is at least configured to execute the transmission control protocol agent to receive a data stream from the client device and to transmit an acknowledgement packet to the client device in response to the data stream from the client device.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a block diagram of a system supporting fault tolerance according to a first embodiment of the present disclosure;

FIG. 2 is a flowchart of a control method of the system supporting fault tolerance according to a first embodiment of the present disclosure;

FIG. 3 is a flowchart of determining whether a fault tolerance mechanism of a virtual machine is activated via a transmission control protocol agent of FIG. 2;

FIG. 4 is a flowchart of a control method of the system supporting fault tolerance according to a second embodiment of the present disclosure;

FIG. 5 is a block diagram of a system supporting fault tolerance according to a second embodiment of the present disclosure;

FIG. 6 is a flowchart of executing an inter-process communication packet monitoring program via the system of FIG. 5 according to an embodiment of the present disclosure;

FIG. 7 is a flowchart of a control method of the system supporting fault tolerance according to a third embodiment of the present disclosure;

FIG. 8 is a block diagram of a system supporting fault tolerance according to a third embodiment of the present disclosure; and

FIG. 9 is a flowchart of executing a data transmission speed monitoring program via the system of FIG. 8 according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

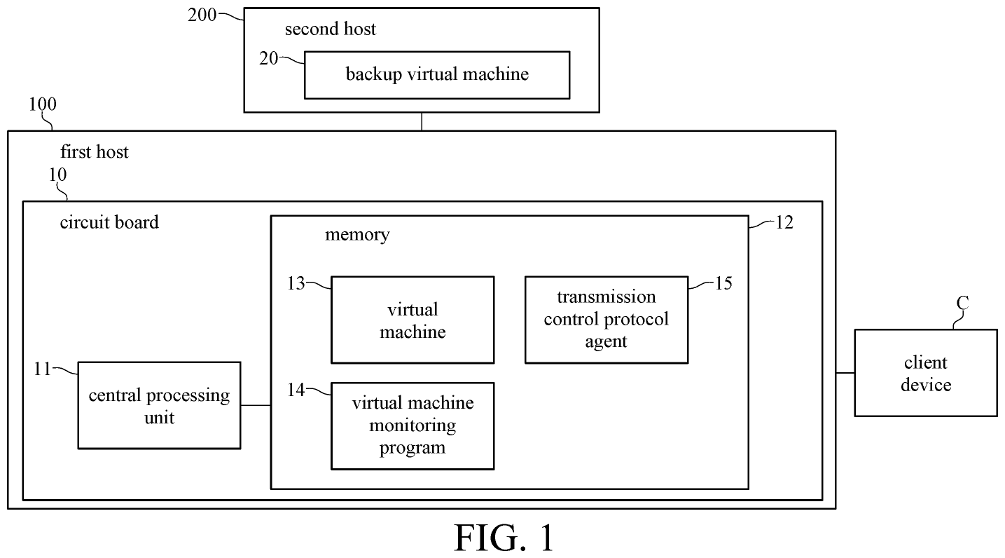

FIG. 1 is a block diagram of a system supporting fault tolerance according to a first embodiment of the present disclosure. As shown in FIG. 1, The system supporting fault tolerance can be applied to several environments, such as FTP, TFTP, WGET, or SSH. The system which supports fault tolerance comprises a first host 100 and a second host 200. The first host 100 communicates with the second host 200 via a local network, and the first host 100 is further configured to communicate with a client device C through an Internet. A communication between the first host 100 and the second host 200 may be a one-way communication or a two-way communication, a communication between the first device 100 and the client device C may be a one-way communication or a two-way communication, a communication between the second device 200 and the client device may be a one-way communication or a two-way communication. For example, the first host 100 and the second host 200 may be two cloud servers with the same hardware architecture, and the client device C may be a personal computer, a mobile communication device, a laptop, a tablet, or a server.

The first host 100 comprises a circuit board 10, a central processing unit 11, and a memory 12. The memory 12 could be a non-temporary memory, a volatile memory or a non-volatile memory. The circuit board 10 is, for example, a main board, and the central processing unit 11 (CPU) and the memory 12 are disposed on the circuit board 10 and the central processing unit 11 and the memory 12 are electrically connected to each other. The memory 12 stores a virtual machine 13, a virtual machine monitoring program 14, and a transmission control protocol agent 15 (TCP agent). The central processing unit 11 executes the virtual machine 13, the virtual machine monitoring program 14 and the transmission control protocol agent 15. States of the virtual machine 13 comprises states of peripheral input/output of the virtual machine 13 and a state of a memory of the virtual machine 13. The virtual machine monitoring program 14 receives an external instruction. When the external instruction is used to activate a fault tolerance mechanism of the virtual machine 13, the virtual machine monitoring program 14 drives the virtual machine 13 to activate the fault tolerance mechanism. When the fault tolerance mechanism of the virtual machine 13 is activated, the virtual machine 13 performs a migration. The migration means that the states of the virtual machine 13 are transferred to the second host 200, so that a backup virtual machine 20 is generated in the second host 200, and states of the backup virtual machine 20 are completely consistent with the states of the virtual machine 13. In other embodiments, the virtual machine 13 and the transmission control protocol agent 15 may be located at different hosts and communicate with each other through the local area network. When the client device C wants to send a data stream to the virtual machine 13 of the first host 100 (means an incoming path), the transmission control protocol agent 15 receives the data stream from the client device C. After receiving the data stream from the client device C, the transmission control protocol agent 15 transmits an acknowledgement packet to the client device C in response to the data stream from the client device C. With regard to a prior system supporting fault tolerance, the acknowledgement packet is transmitted to the client device via the virtual machine. Therefore, a time point for transmitting the acknowledgement packet via the system supporting fault tolerance according to the present disclosure is significantly earlier than a time point for transmitting the acknowledgement packet by the prior system supporting fault tolerance.

In addition, the transmission control protocol agent 15 of the first host 100 is further used to determine whether the fault tolerance mechanism of the virtual machine 13 is activated and whether the states of the virtual machine 13 are completely backed up to the second host 200. The fault tolerance mechanism of the virtual machine 13 sequentially comprises a running state, a snapshot state, a transfer state, and a flush output state. More specifically, the running state means a period during which the virtual machine 13 of the first host 100 continues to operate, the snapshot state means a period during which the states of the virtual machine 13 are backed up, the transfer state means that a period during a backup of the states of the virtual machine 13 is transferred to the second host 200, and the flush output state means a period during the states of the virtual machine 13 are completely transferred to the second host 200. In this embodiment, the fault tolerance mechanism of the virtual machine 13 is implemented by performing multi-threading. Therefore, for the virtual machine 13, the running state and the snapshot state are continuously circulated, and the transfer state and the flush output state are executed in background.

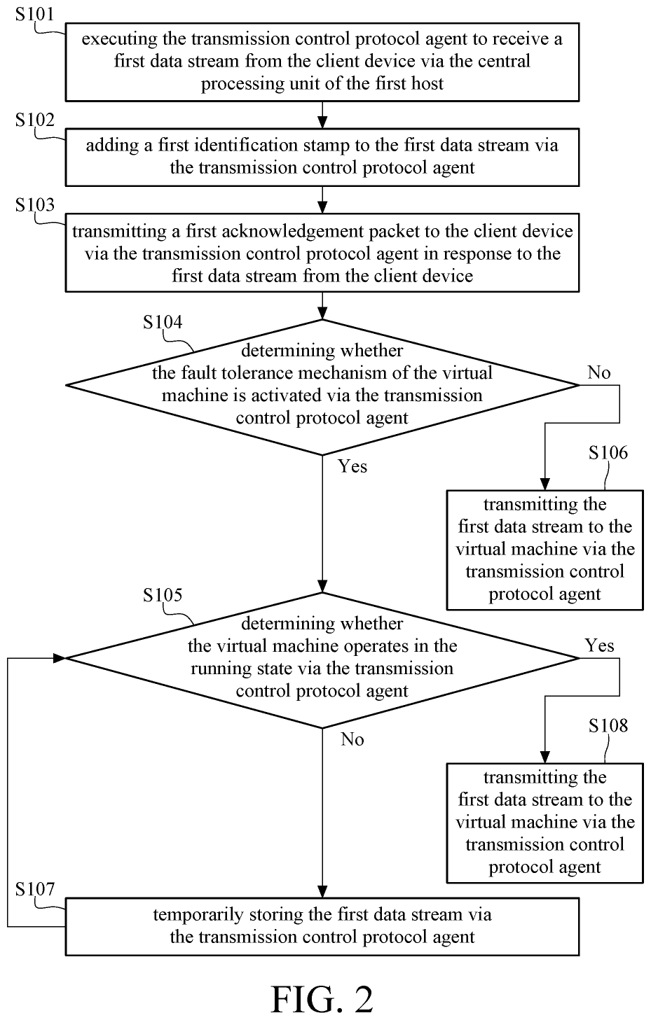

FIG. 2 is a flowchart of a control method of the system supporting fault tolerance according to a first embodiment of the present disclosure. Referring to FIG. 1 and FIG. 2 together, a step S101 is executing the transmission control protocol agent 15 to receive a first data stream from the client device C via the central processing unit 11 of the first host 100, wherein the first data stream includes a plurality of data packets, and the transmission control agent 15 sequentially receives the data packets of the first data stream at different time points.

A step S102 is adding a first identification stamp to the first data stream via the transmission control protocol agent 15, and the first identification stamp indicates a time point when the transmission control agent 15 receives the first data stream. A step S103 is transmitting a first acknowledgement packet to the client device C via the transmission control protocol agent 15 in response to the first data stream from the client device C after the transmission control protocol agent 15 completely receives the first data stream from the client device C, wherein the first acknowledgement packet is read by a client application of the client device C. A step S104 is determining whether the fault tolerance mechanism of the virtual machine 13 is activated via the transmission control protocol agent 15. When the transmission control protocol agent 15 determines that the fault tolerance mechanism of the virtual machine 13 is activated, then a step S105 is performed. The step S105 is determining whether the virtual machine 13 operates in the running state via the transmission control protocol agent 15. When the transmission control protocol agent 15 determines that the fault tolerance mechanism of the virtual machine 13 is not activated, then a step S106 is performed. The step S106 is transmitting the first data stream to the virtual machine 13 via the transmission control protocol agent 15. After the virtual machine 13 completely receives the first data stream from the transmission control protocol agent 15, the virtual machine 13 sends a second acknowledgement packet to the transmission control protocol agent 15.

When the transmission control protocol agent 15 determines that the virtual machine 13 does not operate in the running state, then a step S107 is performed. The step S107 is temporarily storing the first data stream via the transmission control protocol agent 15, then the step S105 is performed. When the transmission control protocol agent 15 determines that the virtual machine 13 operates in the running state, then a step S108 is performed. The step s108 is transmitting the first data stream to the virtual machine 13 via the transmission control protocol agent 15.

A time difference between a first time point and a second time point is the round trip time of the data stream, wherein the client device C receives the first acknowledgement packet from the transmission control protocol agent 15 at the first time point, and the client device C starts transmitting the first data stream to the first host 100 at the second time point. Under the network congestion control of the transmission control protocol, the shorter the round-trip time is, the faster the network transmission speed is.

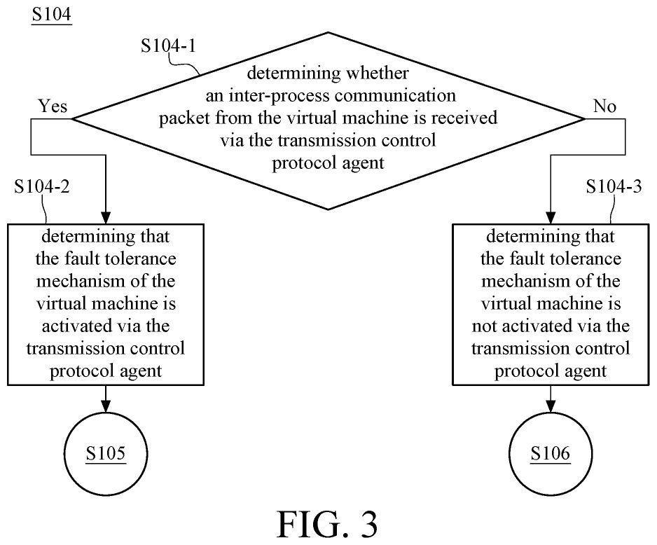

FIG. 3 is a flowchart of determining whether the fault tolerance mechanism of the virtual machine is activated via the transmission control protocol agent of FIG. 2. As shown un FIG. 3, the step S104 comprises sub steps S104-1 to S104-3. The sub step S104-1 is determining whether an inter-process communication (IPC) packet from the virtual machine 13 is received via the transmission control protocol agent 15. When the transmission control protocol agent 15 receives the inter-process communication packet, then the sub step S104-2 is performed. The step S104-2 is determining that the fault tolerance mechanism of the virtual machine 13 is activated via the transmission control protocol agent 15. More specifically, when the fault tolerance mechanism of the virtual machine 13 is activated, the virtual machine 13 continuously transmits inter-process communication packets at different time points to the transmission control protocol agent 15, and each of the inter-process communication packets records a state of the fault tolerance mechanism of the virtual machine 13, and the recorded state of the fault tolerance mechanism of the virtual machine 13 may be the running state, the snapshot state, the transfer state, or the flush output state. When the transmission control protocol agent 15 does not receive the inter-process communication packets, then the sub step S104-3 is performed. The step S104-3 is determining that the fault tolerance mechanism of the virtual machine 13 is not activated via the transmission control protocol agent 15.

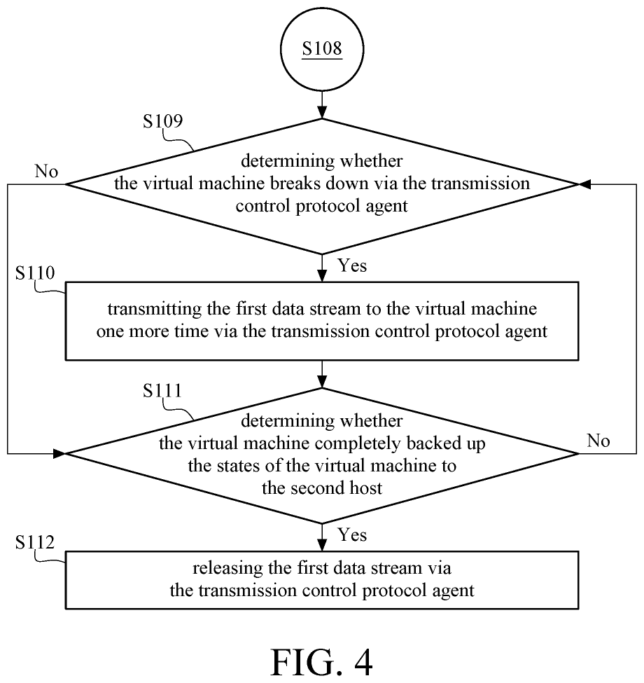

FIG. 4 is a flowchart of a control method of the system supporting fault tolerance according to a second embodiment of the present disclosure. A difference between FIG. 4 and FIG. 2 is that FIG. 4 further comprises steps S109 to S112. As shown in FIG. 4, after the transmission control protocol agent 15 transmits the first data stream to the virtual machine 13, the step S109 is determining whether the virtual machine 13 breaks down via the transmission control protocol agent 15. When the transmission control protocol agent 15 determines that the virtual machine 13 breaks down, then the step S110 is performed. Since the virtual machine 13 which breaks down likely losses the data stream from the transmission control protocol agent 15, therefore the step S110 is transmitting the first data stream to the virtual machine 13 one more time via the transmission control protocol agent 15. After the step S110 is performed, the step S111 is performed. The step S111 is determining whether the virtual machine 13 completely backed up the states of the virtual machine 13 to the second host 200 (means the flush output state of the fault tolerance mechanism). When the transmission control protocol agent 15 determines that the states of the virtual machine 13 are completely backed up to the second host 200, then the step S112 is performed. The step S112 is releasing the first data stream via the transmission control protocol agent 15. When the transmission control protocol agent 15 determines that the states of the virtual machine 13 are not completely backed up to the second host 200, then the step S109 is performed. When the transmission control protocol agent 15 determines that the virtual machine 13 does not break down, then the step S111 is performed.

Since the transmission control protocol agent 15 processes multiple network packets every fixed period, the state of the fault tolerance mechanism of the virtual machine 13 which are read by the transmission control protocol agent 15 are recorded in the latest inter-process communication packet when the data process schedule of the transmission control protocol agent 15 comprises processing the inter-process communication packet. It is assumed that a state of the fault tolerance mechanism recorded in the latest inter-process communication packet and a state of the fault tolerance mechanism recorded in at least one inter-process communication packet which is before the latest inter-process communication packet are flush output states, the transmission control protocol agent 15 delays to transmit the data stream to the client device C when it does not process each of the inter-process communication packets in in real time. For solving the problems described above, the transmission control protocol agent 15 should be designed to process each of the inter-process communication packets in real time.

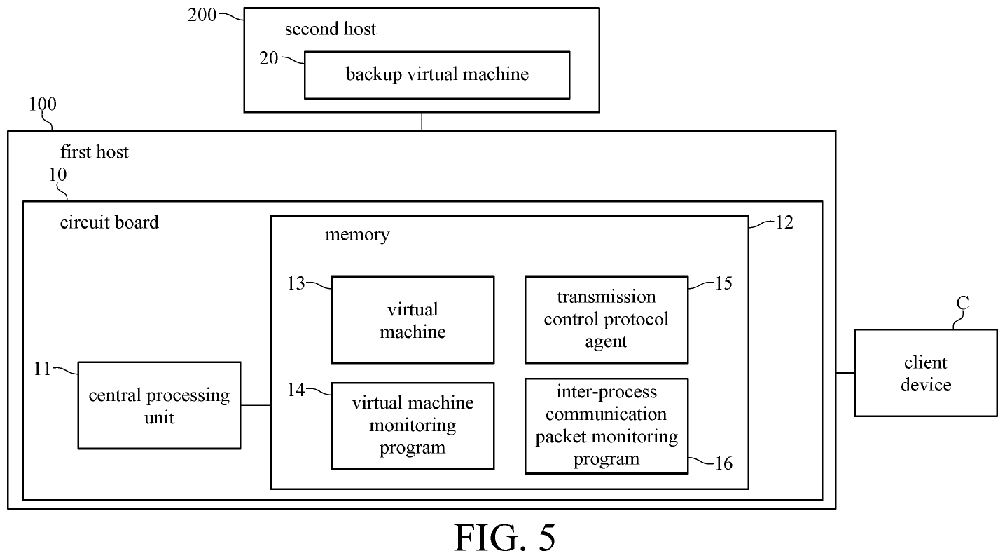

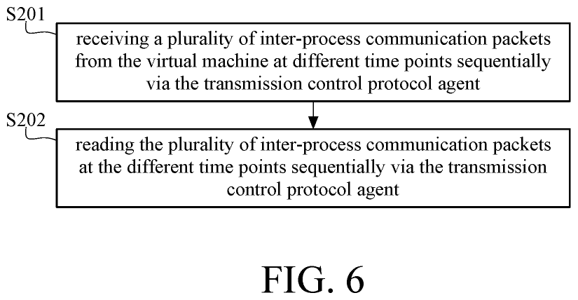

FIG. 5 is a block diagram of a system supporting fault tolerance according to a second embodiment of the present disclosure. A difference between FIG. 5 and FIG. 1 is that the memory 12 further stores an inter-process communication packet monitoring program 16, and the CPU 11 executes the inter-process communication packet monitoring program 16. FIG. 6 is a flowchart of executing the inter-process communication packet monitoring program 16 via the system of FIG. 5 according to an embodiment of the present disclosure. In this embodiment, the control method of the system supporting fault tolerance further comprises executing the inter-process communication packet monitoring program 16, and the transmission control protocol agent 15 can be set to process the inter-process communication packets with the highest priority. As shown in FIG. 6, a step S201 is receiving a plurality of inter-process communication packets from the virtual machine 13 at different time points sequentially via the transmission control protocol agent 15. A step S202 is reading the plurality of inter-process communication packets at the different time points sequentially via the transmission control protocol agent 15 to obtain a plurality of states of the fault tolerance mechanism of the virtual machine 13. More specifically, when the fault tolerance mechanism of the virtual machine 13 is activated, the virtual machine 13 will continuously transmit the inter-process communication packets to the transmission control protocol agent 15, so the transmission control protocol agent 15 may process each of the inter-process communication packets in real time, thereby obtaining a present state of the fault tolerance mechanism of the virtual machine 13. Conversely, when the fault tolerance mechanism of the virtual machine 13 is not activated, the virtual machine 13 does not transmit the inter-process communication packets to the transmission control protocol agent 15.

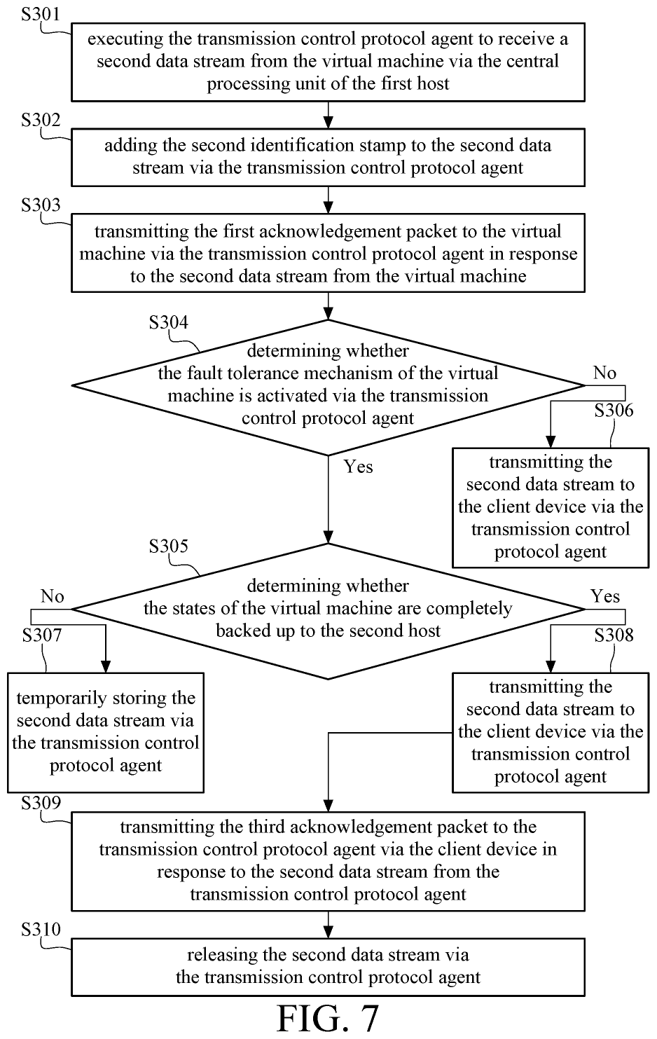

FIG. 7 is a flowchart of a control method of the system supporting fault tolerance according to a third embodiment of the present disclosure. As shown in FIG. 7, A step S301 is executing the transmission control protocol agent 15 to receive a second data stream from the virtual machine 13 via the central processing unit 11 of the first host 100, wherein the second data stream includes a plurality of data packets, and transmission control protocol agent 15 sequentially receives the data packets of the second data stream at different time points. A step S302 is adding the second identification stamp to the second data stream via the transmission control protocol agent 15, and the second identification stamp indicates a time point of receiving the second data stream by the transmission control protocol agent 15 and a state of the second data stream at the time point of receiving the second data stream. A step S303 is transmitting the first acknowledgement packet to the virtual machine 13 via the transmission control protocol agent 15 in response to the second data stream from the virtual machine 13 after the transmission control protocol agent 15 completely receives the second data stream from the virtual machine 13. A step S304 is determining whether the fault tolerance mechanism of the virtual machine 13 is activated via the transmission control protocol agent 15. When the transmission control protocol agent 15 determines that the fault tolerance mechanism of the virtual machine 13 is activated, then a step S305 is performed. The step S305 is determining whether the states of the virtual machine 13 are completely backed up to the second host 200. When the transmission control protocol agent 15 determines that the fault tolerance mechanism of the virtual machine 13 is not activated, a step S306 is performed. The step S306 is transmitting the second data stream to the client device C via the transmission control protocol agent 15. After the client device C completely receives the second data stream from the transmission control protocol agent 15, the client device C transmits a third acknowledgement packet to the transmission control protocol agent 15.

When the transmission control protocol agent 15 determines that the states of the virtual machine 13 are not completely backed up to the second host 200, then a step S307 is performed. The step S307 is temporarily storing the second data stream via the transmission control protocol agent 15. When the transmission control protocol agent 15 determines that the states of the virtual machine 13 are completely backed up to the second host 200, then a step S308 is performed. The step S308 is transmitting the second data stream to the client device C via the transmission control protocol agent 15, then a step S309 is performed. The step S309 is, transmitting the third acknowledgement packet to the transmission control protocol agent 15 via the client device C in response to the second data stream from the transmission control protocol agent 15 after the client device C completely receives the second data stream from the transmission control protocol agent 15, then a step S310 is performed. The step S310 is releasing the second data stream via the transmission control protocol agent 15 after the transmission control protocol agent 15 reads the third acknowledgement packet from the client device C.

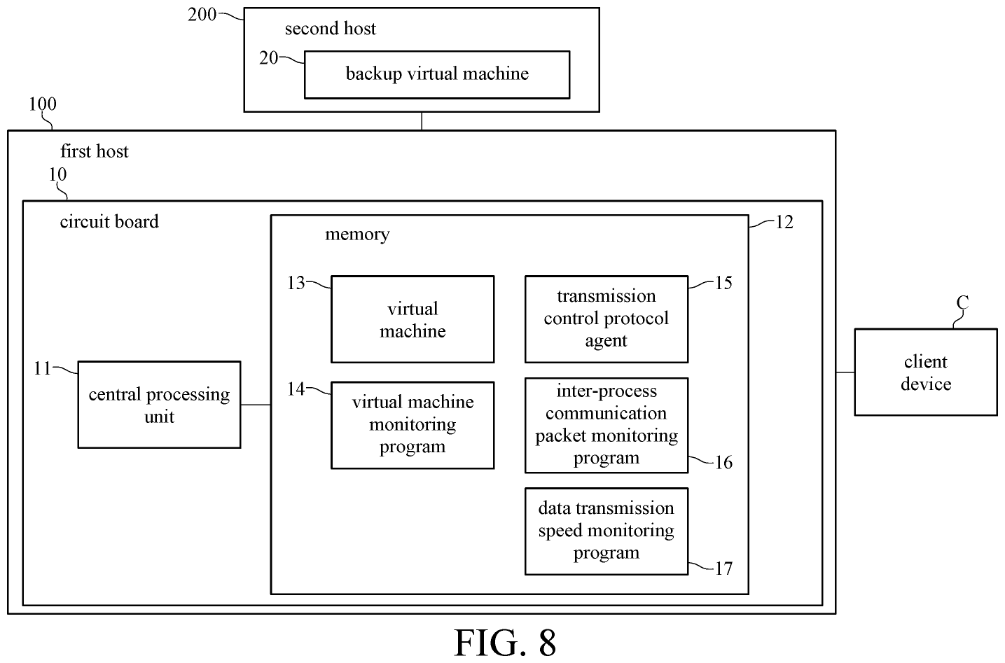

Because the communication between the transmission control protocol agent 15 and the virtual machine 13 is usually through a local area network or is within the same host, and the communication between the transmission control protocol agent 15 and the client device C is usually through an internet network. Therefore, a first data transmission speed between the transmission control protocol agent 15 and the virtual machine 13 is usually much higher than a second data transmission speed between the transmission control protocol agent 15 and the client device C. With respect to a data path between the virtual machine 13 and the client device C, when too many data packets are accumulated in the transmission control protocol agent 15 without being processed, the memory resources are possibly exhausted and data packets are possibly lost. In order to solve the above problem, a system supporting fault tolerance according to a third embodiment of the present disclosure is provided. FIG. 8 is a block diagram of the system supporting fault tolerance according to the third embodiment of the present disclosure. A difference between FIG. 8 and FIG. 1 is that the memory 12 further stores a data transmission speed monitoring program 17, and the CPU 11 executes the data transmission speed monitoring program 17.

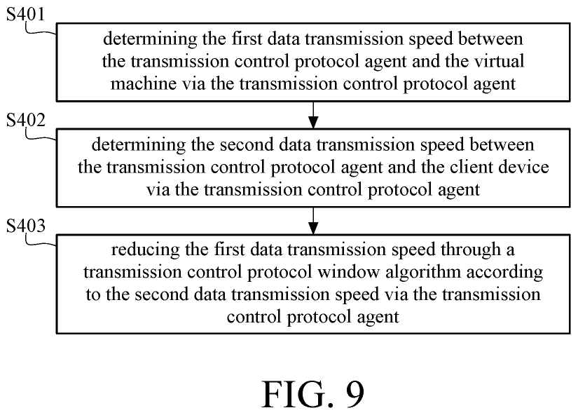

In addition to the fault tolerance mechanism and the inter-process communication packet monitoring program 16, the control method of the system supporting fault tolerance further comprises the data transmission speed monitoring program 17. FIG. 9 is a flowchart of executing the data transmission speed monitoring program via the system of FIG. 8 according to an embodiment of the present disclosure. As shown in FIG. 9, a step S401 is determining the first data transmission speed between the transmission control protocol agent 15 and the virtual machine 13 via the transmission control protocol agent 15. A step S402 is determining the second data transmission speed between the transmission control protocol agent 15 and the client device C via the transmission control protocol agent 15, wherein the second data transmission speed is slower than the first data transmission speed. In other embodiment, the step S402 can be before the step S401. A step S403 is reducing the first data transmission speed through a transmission control protocol window algorithm according to the second data transmission speed via the transmission control protocol agent 15. More specifically, an underlying hardware of the first host 100 stores a host operating system of the virtual machine 13 and a host operating system of the transmission control protocol agent 15. The host operating system of the virtual machine 13 may be the same as or different from the host operating system of the transmission control protocol agent 15. The host operating system of the virtual machine 13 may establish a plurality of first windows of the virtual machine 13, wherein the plurality of first windows are related to transmission control protocol. The host operating system of the transmission control protocol agent 15 may establish a plurality of second windows of the transmission control protocol agent 15, wherein the plurality of second windows are related to transmission control agreement. When the virtual machine 13 transmits the data packets to the transmission control protocol agent 15, the host operating system of the transmission control protocol agent 15 transmits an acknowledgement packet to the host operating system of the virtual machine 13 in response to the data packets from the virtual machine 13, so that the information related to the number of the second windows which is not filled with the data packets can be transmitted to the host operating system of the virtual machine 13. The virtual machine 13 determines whether to continue transmitting the data packets to the transmission control protocol agent 15 according to the acknowledgement packet. When all of the second windows are filled with the data packets, the virtual machine 13 can't be able to transmit the data packets to the transmission control protocol agent 15 until the transmission control protocol agent 15 takes the data packets away from the second windows.

The first transmission speed between the transmission control protocol agent 15 and the virtual machine 13 may be reduced via the transmission control protocol window algorithm. In one embodiment, when the remaining memory resources of the first host 100 is greater than or equal to a preset percentage lower limit, the transmission control protocol agent 15 does not take any data packets away from the second windows. The transmission control protocol agent 15 does not take the data packets away from the second windows until the remaining memory resource of the first host 100 is less than the percentage lower limit. In another embodiment, the transmission control protocol agent 15 does not take the data packets away from the second windows until the second windows of the transmission control protocol agent 15 are filled with the data packets.

When the system which supports fault tolerance has multiple virtual machines and periods of the fault tolerance mechanisms of the virtual machines are not completely the same, an amount of data processed by each of the virtual machines must be further controlled. A formula of data flow (bit per second) for each of the virtual machines is defined by (an amount of data transmitted from the system with fault tolerance to the client device)/(the number of the virtual machines). A formula of an amount of data processed by each of the virtual machines during one period of the fault tolerance mechanism is defined by (data flow) * (a period of the fault tolerance mechanism). In other embodiments, a priority of the virtual machine is determined by an importance degree of data processed by the virtual machine, and a priority scheduling algorithm assigns a specific data flow for a virtual machine which has the highest priority. In other embodiment, a guaranteed minimum transmission algorithm assigns a bandwidth lower limit for each of the virtual machines. When the bandwidth lower limit is “X” Megabit per second, a formula of a minimum amount of data transmitted by the virtual machine is defined by

$${Σ}_{1}^{n} ( n X - \frac{t}{n} ) ,$$

wherein “n” is a transmission time, and “t” is a total amount of data transmitted by the virtual machine.

In view of the above description, the time needed for receiving the acknowledgement packet by the virtual machine or the client application can be greatly reduced because the transmission control protocol agent is responsible for transmitting the acknowledgement packet and storing the data packets temporarily. As a result, the round-trip time for transmitting the data packets can be significantly reduced. Conversely, when the fault tolerance mechanism of a past virtual machine is activated, the virtual machine only can receive the acknowledgement packet after the running state, the snapshot state, the transfer state, and the flush output state are finished. The time needed for receiving the acknowledgement packet via the virtual machine is increased sharply because the sum of time needed for executing the running state, the snapshot state, the transfer state, and the flush output state, and the round-trip time is increased. Under the network congestion control of the transmission control protocol, the shorter the round-trip time is, the faster a network transmission speed is. Therefore, a network transmission speed of the system supporting fault tolerance according to the present disclosure is higher that a network transmission speed of a prior system supporting fault tolerance. When the network transmission speed is faster, the time needed for transmitting data can be reduced.

What is claimed is:

1. A control method of a system supporting fault tolerance, wherein the system comprises a first host and a second host and the first host and the second host are configured to connected to a client device via an internet, the first host stores a virtual machine and a transmission control protocol agent, and with the control method comprising:
executing the transmission control protocol agent to receive a data stream from the client device via the first host;
transmitting an acknowledgement packet to the client device via the transmission control protocol agent in response to the data stream from the client device;
determining whether a fault tolerance mechanism of the virtual machine is activated via the transmission control protocol agent;
determining whether the virtual machine operates in a running state via the transmission control protocol agent when the transmission control protocol agent determines that the fault tolerance mechanism of the virtual machine is activated;
temporarily storing the data stream via the transmission control protocol agent when the transmission control protocol agent determines that the virtual machine is not in the running state; and
transmitting the data stream to the virtual machine via the transmission control protocol agent when the transmission control protocol agent determines that the virtual machine operates in the running state.

2. The control method in claim 1, further comprising transmitting the data stream to the virtual machine via the transmission control protocol agent when the transmission control protocol agent determines that the fault tolerance mechanism of the virtual machine is not activated.

3. The control method in claim 1, further comprising adding an identification stamp to the data stream via the transmission control protocol agent when the transmission control protocol agent receives the data stream, wherein the identification stamp is used to indicate a time point of receiving the data stream via the transmission control protocol agent.

4. The control method in claim 1, wherein determining whether the fault tolerance mechanism of the virtual machine is activated comprise:
determining whether an inter-process communication packet from the virtual machine is received via the transmission control protocol agent; and
determining that the fault tolerance mechanism of the virtual machine is activated via the transmission control protocol agent when the transmission control protocol agent receives the inter-process communication packet.

5. The control method in claim 1, wherein further comprising determining whether the virtual machine breaks down via the transmission control protocol agent after the transmission control protocol agent transmits the data stream to the virtual machine, wherein the transmission control protocol agent transmits the data stream to the virtual machine one more time when the transmission control protocol agent determines that the virtual machine breaks down, and the transmission control protocol agent determines whether states of the virtual machine are completely backed up to the second host when the transmission control protocol agent determines that the virtual machine does not break down.

6. The control method in claim 5, wherein further comprising determining whether the states of the virtual machine are completely backed up to the second host via the transmission control protocol agent after the transmission control protocol agent transmits the data stream to the virtual machine one more time; wherein the transmission control protocol agent releases the data stream when the states of the virtual machine are completely backed up to the second host, and the transmission control protocol agent determines whether the virtual machine breaks down one more time when the states of the virtual machine are not completely backed up to the second host.

7. A control method of a system supporting fault tolerant, wherein the system comprises a first host and a second host and the first host and the second host are configured to connected to a client device via an internet, the first host stores a virtual machine and a transmission control protocol agent, and with the control method comprising:
executing the transmission control protocol agent to receive a data stream from the virtual machine via the first host;
transmitting an acknowledgement packet to the virtual machine via the transmission control protocol agent in response to the data stream from the virtual machine;
determining whether a fault tolerance mechanism of the virtual machine is activated via the transmission control protocol agent;
determining whether states of the virtual machine are completely backed up to the second host via the transmission control protocol agent when the transmission control protocol agent determines that the fault tolerance mechanism of the virtual machine is activated;
temporarily storing the data stream via the transmission control protocol agent when the transmission control protocol agent determines that the states of the virtual machine are not completely backed up to the second host; and
transmitting the data stream to the client device via the transmission control protocol agent when the transmission control protocol agent determines that the states of the virtual machine are completely backed up to the second host.

8. The control method in claim 7, further comprising adding an identification stamp to the data stream via the transmission control protocol agent when the transmission control protocol agent receives the data stream, wherein the identification stamp is used to indicate a time point of receiving the data stream via the transmission control protocol agent.

9. The control method in claim 7, wherein determining whether the fault tolerance mechanism of the virtual machine is activated comprise:
determining whether an inter-process communication packet from the virtual machine is received via the transmission control protocol agent; and
determining that the fault tolerance mechanism of the virtual machine is activated via the transmission control protocol agent when the transmission control protocol agent receives the inter-process communication packet.

10. The control method in claim 7, further comprising transmitting the data stream to the client device via the transmission control protocol agent when the transmission control protocol agent determines that the fault tolerance mechanism of the virtual machine is not activated.

11. The control method in claim 7, further comprising releasing the data stream via the transmission control protocol agent after the transmission control protocol agent transmits the data stream to the client device.

12. The control method in claim 7, further comprising executing an inter-process communication packet monitoring program via the first host, wherein the inter-process communication packet monitoring program comprises:
receiving a plurality of inter-process communication packets from the virtual machine at different time points sequentially via the transmission control protocol agent; and
reading the inter-process communication packets at the time points sequentially via the transmission control protocol agent to obtain a plurality of states of the fault tolerance mechanism of the virtual machine.

13. The control method in claim 7, further comprising executing a data transmission speed monitoring program, wherein the data transmission speed monitoring program comprises: determining a first data transmission speed between the transmission control protocol agent and the virtual machine via the transmission control protocol agent; determining a second data transmission speed between the transmission control protocol agent and the client device via the transmission control protocol agent, wherein the second data transmission speed is slower than the first data transmission speed; reducing the first data transmission speed through a transmission control protocol window algorithm according to the second data transmission speed via the transmission control protocol agent.

14. A system supporting fault tolerance, comprising:
a first host, storing a virtual machine and a transmission control protocol agent, wherein the first host is configured to connect to a client device via an internet; and
a second host, connecting to the first host via the internet;
wherein the first host is at least configured to execute the transmission control protocol agent to receive a data stream from the client device and to transmit an acknowledgement packet to the client device in response to the data stream from the client device.

15. The system in claim 14, wherein the first host is further configured to execute the transmission control protocol agent to determine whether a fault tolerance mechanism of the virtual machine is activated.

16. The system in claim 14, wherein the first host is further configured to execute the transmission control protocol agent to determine whether states of the virtual machine are completely backed up to the second host.

17. The system in claim 14, wherein the transmission control protocol agent adds an identification stamp to the data stream when the transmission control protocol agent receives the data stream, and the identification stamp indicates a time point of receiving the data stream via the transmission control protocol agent.

18. The system in claim 14, wherein the first host comprises a circuit board, a central processing unit, and a memory, the central processing unit and the memory are disposed on the circuit board and are electrically connected to each other, the memory stores the virtual machine, a virtual machine monitoring program and the transmission control protocol agent, and the central processing unit is configured to execute the virtual machine, the virtual machine monitoring program and the transmission control protocol agent.

19. The system in claim 18, wherein the virtual machine monitoring program is used to receive an external instruction, the virtual machine monitoring program activates a fault tolerance mechanism of the virtual machine when a content of the virtual machine monitoring program is to activate the fault tolerance mechanism of the virtual machine.
